(19) United States
(12) Patent Application Publication
(10) Pub. No.: US 2017/0125867 A1
(43) Pub. Date: May 4, 2017

(54) SUPPORT DEVICE FOR A TUBE, IN PARTICULAR A TUBE OF A HEAT EXCHANGER INTENDED TO COME INTO CONTACT WITH A MOTOR VEHICLE BATTERY

(71) Applicant: Valeo Systemes Thermiques, Le Mesnil Saint Denis (FR)

(72) Inventors: Elise Beaurepaire, Le Mans (FR); Fethy Djallal, Le Mans (FR); Marc Herry, Le Mans (FR); Julien Veron, Le Mans (FR); Jean Christophe Prevost, Ligron (FR)

(73) Assignee: Valeo Systemes Thermiques, Le Mesnil Saint Denis (FR)

(21) Appl. No.: 15/307,901

(22) PCT Filed: Apr. 30, 2015
(86) PCT No.: PCT/EP2015/059608

§ 371 Date: Dec. 2, 2016

(30) Foreign Application Priority Data
Apr. 30, 2014 (FR) 1453916

(51) Int. Cl. H01M 10/66; B60L 11/18; H01M 10/6556; H01M 10/625; H01M 10/613

(52) U.S. Cl. CPC H01M 10/66; H01M 10/625; H01M 10/613; H01M 10/6556; B60L 11/1874; H01M 2220/20; B60Y 2200/91

(57) ABSTRACT

The invention relates to a support device for a tube, in particular for a tube of a heat exchanger intended to come up against a vehicle battery for the purpose of its cooling, the device comprising a base, on which the tube is intended to be mounted, and a compression element (1), said base and said compression element (1) comprising a contact zone (25), extending in a direction d, known as the direction of contact, said base and said compression element (1) being intended to come into contact via their contact zone (25) when said compression element (1) is under stress, said contact zone of the compression element (1) and/or said contact zone of the base exhibiting an evolutive configuration in said direction of contact d.

The present invention relates to a support device for a tube, in particular for a tube of a heat exchanger, intended to come into contact with a motor vehicle battery, in particular for the cooling of this battery.

The new electric motor technologies for motor vehicles depend on increasingly powerful batteries which require thermoregulation, in particular cooling.

Heat exchangers having flat tubes coming into contact with the surfaces of the batteries are known for this purpose.

Different solutions have been proposed, although these remain insufficient, in order to ensure good contact between the battery and the tubes in spite of the different installation clearances that may be present.

The invention is intended to improve the situation.

The invention relates for this purpose to a support device for a tube, in particular for a tube of a heat exchanger intended to come up against a vehicle battery for the purpose of its cooling, the device comprising a base, on which the tube is intended to be mounted, and a compression element, said base and said compression element comprising a contact zone, extending in a direction d, known as the direction of contact, said base and said compression element being intended to come into contact via their contact zone when said compression element is under stress.

According to the invention, said contact zone of the compression element and/or said contact zone of the base exhibits an evolutive configuration in said direction of contact d.

Thanks to the evolutive configuration of the one or more contact zones, it is possible for the compression force of the spring to be adjusted over its length and for any installation clearances to be absorbed, such that the contact between the battery and the exchanger is optimized. It is possible in particular to compensate for the edge effects in the area of the longitudinal extremities of said base and/or of said compression element.

According to various characterizing features of the invention, which may be considered jointly or individually:
said direction of contact is intended to be oriented in a longitudinal direction of the tube,
the compression element includes edges that are configured in order to be supported on a supporting surface,
said edges are positioned to either side of said contact zone of said compression element,
said edges are two in number, opposite one another in relation to the contact zone,
said edges extend, in particular continuously, in the direction of contact d,
the contact zone of said compression element and/or of said base is a strip exhibiting a variable width in said direction of contact d,
said base comprises a first face configured in order to support the tube and a second face to which the compression element is intended to be applied, once it has been placed under stress,
said compression element is received in a concave zone or a recess of said second face, said concave zone or recess defining said contact zone of the base,
the compression element is a spring in the form of a strip having a rounded peak, or substantially in the form of an upside-down gutter, said rounded peak of the spring defining said contact zone of the compression element.

According to a first aspect of the invention:
said concave zone or recess exhibits an evolutive depth in said direction d,
said concave zone or recess is less deep in the area of its longitudinal extremities.

According to a second aspect of the invention, which may or may not be combined with the first aspect:
said rounded peak of the spring exhibits a variable radius of curvature R in said direction d,
said radius R is smaller at each of the longitudinal extremities of said compression element,
said radius R varies in a linear fashion in said direction d,
the ratio of the smallest radius to the largest radius is comprised between 0.5 and 1, preferably between 0.7 and 0.9.

The invention also relates to a base of the support device according to the first aspect of the invention mentioned earlier.

The invention further relates to a compression element of the support device according to the second aspect of the invention mentioned earlier. Such a compression element may be configured in order to be supported directly against the tube without falling outside the scope of the invention.

The invention also relates to a heat exchanger assembly, comprising tubes, and a plurality of support devices, as described above, supporting said tubes.

The invention further relates to a battery comprising such an assembly.

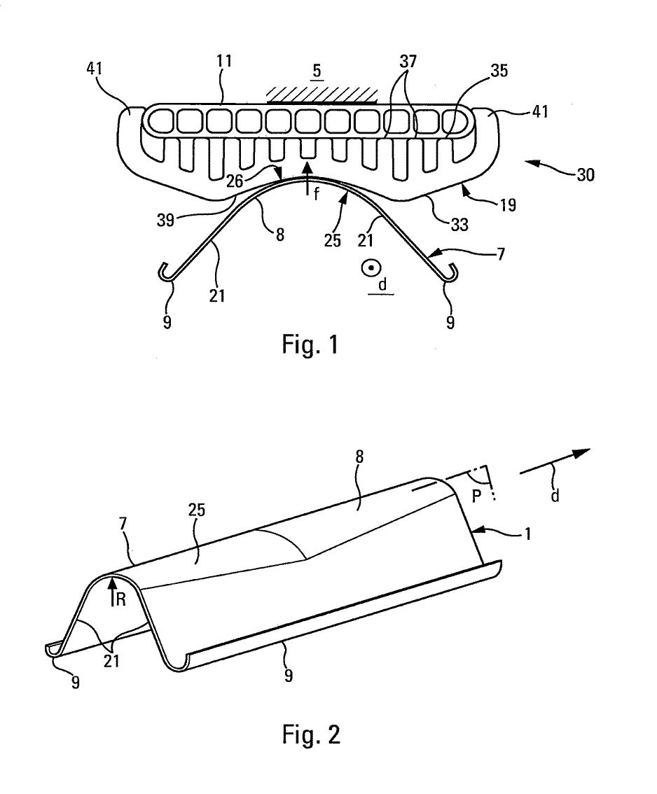

Other characterizing features and advantages of the invention will become apparent from a perusal of the following description of illustrative embodiments given by way of illustration with reference to the accompanying drawings, in which:
FIG. 1 is a view in transverse section of a support device according to the invention illustrating how said device permits the application of a tube of a heat exchanger against a battery.
FIG. 2 is a view in perspective of a compression element according to an embodiment of the invention.

Identical numerical references are used to designate identical or similar elements.

As illustrated in FIG. 1, the invention relates, first of all, to a support device for a tube 11. The tube in this case is a tube 11 for a heat exchanger intended to come up against a vehicle battery 5 for the purpose of its thermoregulation, in particular its cooling.

Said device comprises a base 19 on which the tube 11 is mounted, and a compression element 1. Said base 19 and said compression element 1 exhibit a contact zone 25, extending in a direction d, known as the direction of contact, said base 19 and said compression element 1 being intended to come into contact via their contact zone when said compression element 1 is under stress. Advantageously, said direction of contact is intended to be oriented in a longitudinal direction of the tube, in this particular case being a direction orthogonal to the plane of the figure.

Still in FIG. 1, the compression element 1 is illustrated at rest, and the contact zones 25 of said compression element 1 and of said base 19 remain at a distance. When said compression element 1 is under stress, on the other hand, the compression element 1 is applied against the base 19 and it is deformed. Their contact zone 25 are then situated one against the other. The compression element 1 in this way exerts a force on the base 19, in the area of their contact zone 25, which force is transmitted to the tube 11 which is thereby pressed against the battery 5.

The device is positioned in particular underneath the battery 5, and it is intended to press the one or more tubes 11 of the heat exchanger 3 against a bottom face of the battery 5.

Said base 19 advantageously includes a first face 35 configured in order to support the tube 11 in a manner that is insulated thermally and a second face 33 to which the compression element 1 is intended to be applied when the latter is placed under stress.

Said first and second faces 33, 35 are situated advantageously opposite one another, in such a way that the force applied by the compression element 1 to the second face 33, according to the arrow f in the figure, is transmitted directly to the tube 11 via the first face 35.

It would also be possible to propose returning the force in a direction oriented at an angle, other than that of the example.

Said base 19 is provided advantageously with grooves 37 on its first face, intended to be applied to the tube via their extremity, which enhances the ability to keep the tube thermally insulated via the base. This thermal insulation similarly results from the material of the base advantageously being heat-insulating, for example being made of an insulating plastic material. Electrical insulation with the tube is similarly assured.

Said base 19 is advantageously configured in order to be mounted by snap-fitting on the one or more said tubes 11. For this purpose, said base 19 is provided in this case with snap-fitting sections 41 for the tube, in particular with feet 41 for holding the tube on its longitudinal sides. These feet 41 are capable of gripping the tube, by means of a snap fit, without making contact with the battery.

Elements for connecting the compression element to the intermediate support may be provided in addition, albeit not illustrated here, for example hooks disposed at regular intervals over the length of the base, mounted crosswise in the compression element.

Said compression element 1 comprises, for example, a spring-effect fitting 7 configured in order to be supported on a supporting surface, which may be that of the housing for the battery 5, for example an enclosure for housing the battery mounted on the vehicle, albeit not illustrated here. Said spring-effect fitting 7 is provided, for example, with two opposite and parallel edges 9, likewise being intended to extend in the direction of contact d. Said edges 9 are configured in this case in order to be applied in a continuous manner against the support. The edges in this case could be folded edges.

Alternatively, the fitting may include more than two edges, the latter not necessarily being parallel.

The force of compression of the spring must be of an amplitude sufficient to exert the pressing of the tube 11 against the battery 5, which involves the configuration of the spring fitting, in particular in respect of its stiffness, for this purpose.

The fitting 7 in this case is a spring in the form of a strip having a rounded peak 8, that is to say substantially in the form of an upside-down gutter. Said peak 8 of the spring is capable of being disposed, in compression, in contact against said base 19 of said tube. In other words, said peak 8 defines said contact zone 25 of said compression element 1. Said contact zone 25 may be assimilated in this case into a contact strip, in particular situated to either side of a longitudinal median plane P.

Said peak 8 extends in said direction of contact d, in particular over the length of the base 19, which may correspond substantially to that of the tube 11. Said spring strip is capable of being mounted flexibly on the supporting surface in order to be applied against said base 19.

Said spring strip 7 in this case includes two opposite legs 21, in particular being symmetrical in relation to the longitudinal median plane P of the strip. Said legs 21 are configured in order to be mobile on the supporting surface, in particular via their edges 9.

When configured in this way, said fitting 7 in compression exerts a force on said exchanger via said peak 8, that is to say a pressure against the tube 11, which places the tube and the battery in contact with a view to the transfer of heat from one to the other.

Said spring strip 7 advantageously has a thickness equal to about 0.1 to 0.4 mm, preferably having a thickness of between 0.15 and 0.2 mm, constituted by a metallic material, in particular steel having a high spring characteristic, which confers a good bending fatigue strength in order to apply said pressing of the exchanger against the battery.

Said spring strip 7, for example, has a length of between 200 and 500 millimeters, adapted to the length of the one or more said tubes 11.

According to the invention, said contact zone of the compression element 1 and/or said contact zone of the base 19 exhibits an evolutive configuration in the direction of contact d. In this way, it is possible to obtain a more constant force along the entire length of said compression device. The existence of a clearance between the battery 5 and the tube 11, in particular in the area of the longitudinal extremities of said tube 11, is avoided in this way.

As illustrated in FIG. 2, according to a first embodiment of the invention, said peak 8 exhibits a variable radius R over the length of the latter, for example it decreases from the middle to the extremity, as in the present case.

Thus, thanks to said fitting spring 7, of which the peak radius R is variable over the length, it is possible for the compression force of the spring to be adjusted over its length and for any installation clearances to be absorbed, such that the contact between the battery and the exchanger is optimized.

The edges 9 remain parallel, and the height of the peak relative to the supporting surface varies, in particular being larger in order to adapt to a smaller radius. This can be seen at rest and under compression, the contact being established on the tube, along its surface.

The peak radius R is advantageously smaller at least at one longitudinal extremity of the peak, for example, as in the present case, at each of the longitudinal extremities of the peak or longitudinal extremities of the spring strip. The height of said peak relative to the supporting surface, which is larger in the area of the extremity, at rest, increases the compression force of the spring at said extremity and compensates for the reducing edge effect of the compression force of the spring in this area.

The section radius of the peak varies, in particular, in a linear manner in respect of its length, advantageously in a symmetrical manner relative to a transverse median plane, such that said compression force increases linearly from the middle to each extremity.

The ratio of the smallest radius to the largest radius may be comprised between 0.5 and 1, preferably between 0.7 and 0.9, and in particular between 0.8 and 0.9.

Referring back to FIG. 1, it can be established that said rounded peak 8 of the spring is advantageously received in a concave zone or a recess 39 of said second face, which helps to facilitate maintaining the spring in position on the second face. Said concave zone or recess 39 in this case defines said contact zone 25 of said base 19.

According to another embodiment of the invention, albeit not illustrated here, said concave zone or recess 39 exhibits an evolutive depth in said direction d. Said concave zone or recess 39 could in particular be less deep in the area of its longitudinal extremities. Such a step, possibly combined with a variation in the radius of curvature of the peak 8 of the spring, similarly makes it possible to enhance the homogeneity of the forces transmitted to the tube 11.

Said recess 39 could also be configured according to the example in order to correspond to a maximum extension of the spring, in particular by being adapted to the variation in the radius R, such that, in compression, said recess corresponds in respect of its form to the peak of the spring.

The invention thus offers a simple, reliable and easily implemented solution in order to ensure an effective thermal transfer between a vehicle battery and a heat exchanger.

As a variant, the compression element 1 is thus supported on the one or more said tubes 11 without a base or an intermediate support section 19. In other words, the effort imposed by the spring 7 is exerted directly on the one or more said tubes 11 of the exchanger.

Said exchanger comprises, for example, a plurality of tubes 11, each provided with a support device as described above. In FIG. 1, one of said tubes is represented in cross section. The tube in this case is a flat tube, in particular being extruded, provided with a plurality of channels for the passage of a heat transfer medium, in particular a cooling medium such as water mixed with antifreeze. Said tube 11 comprises two large faces, one being situated in contact with said base 19 and the other being situated in contact with said battery 5. As a variant, one and the same support device may be utilized in order to support several tubes of said exchanger.

Although not illustrated here, said exchanger comprises in addition, for example, manifolds into which said tubes discharge at each of their longitudinal extremities. Said tubes are advantageously disposed in one and the same plane, parallel to their large faces, in such a way as to be capable of coming into contact with a substantially plane surface of the battery.

1. A support device for a tube of a heat exchanger intended to come up against a vehicle battery for the purpose of cooling the battery, the support device comprising:
a base, on which the tube is mounted; and
a compression element,
said base and said compression element comprising a contact zone, extending in a direction d, known as the direction of contact, said base and said compression element being in contact via their contact zone when said compression element is under stress,
said contact zone of the compression element and/or said contact zone of the base exhibiting an evolutive configuration in said direction of contact d.

2. The device as claimed in claim 1, wherein the contact zone of said compression element and/or of said base is a strip exhibiting a variable width in said direction of contact d.

3. The device as claimed in claim 1, wherein said base comprises a first face configured to support the tube and a second face to which the compression element is applied, once under stress, said compression element being received in a concave zone or a recess of said second face, said concave zone or recess defining said contact zone of said and exhibiting an evolutive depth in said direction d.

4. The device as claimed in claim 3, wherein said concave zone or recess is less deep in the area of its longitudinal extremities.

5. The device as claimed in claim 1, wherein the compression element is a spring in the form of a strip having a rounded peak, or substantially in the form of an upside-down gutter, said rounded peak of the spring defining said contact zone of said compression element and exhibiting a variable radius of curvature R in said direction d.

6. The device as claimed in claim 5, wherein said radius R is plus petit at each of the longitudinal extremities of said compression element.

7. The device as claimed in claim 5, wherein said radius R varies in a linear fashion in said direction d.

8. The device as claimed in claim 5, wherein the ratio of the smallest radius to the largest radius is comprised between 0.5 and 1.

9. A base of the support device as claimed in claim 3.

10. A compression element of the support device as claimed in claim 5.

11. A heat exchanger assembly, comprising tubes, and a plurality of support devices, as claimed in claim 1, supporting said tubes.

12. A battery comprising an assembly as claimed in claim 11.
